(19) United States
(12) Patent Application Publication
(10) Pub. No.: US 2024/0253440 A1
(43) Pub. Date: Aug. 1, 2024

(54) GLASS RUN

(71) Applicant: TOYODA GOSEI CO., LTD., Kiyosu-shi (JP)

(72) Inventors: Tasuku ISHIGURO, Kiyosu-shi (JP); Masatoshi NOJIRI, Kiyosu-shi (JP); Yasuhiro SHIMIZU, Kiyosu-shi (JP)

(21) Appl. No.: 18/408,760

(22) Filed: Jan. 10, 2024

(30) Foreign Application Priority Data
Jan. 27, 2023 (JP) 2023-010711

(51) Int. Cl. B60J 10/76; B60J 1/17; B60J 10/27

(52) U.S. Cl. CPC B60J 10/76; B60J 1/17; B60J 10/27

(57) ABSTRACT

The glass run includes at least one of a vehicle outer seal lip extending from the vehicle outer side wall toward the bottom wall to slide with a vehicle outer surface of the door glass, and a vehicle inner seal lip extending from the vehicle inner side wall toward the bottom wall to slide with a vehicle inner surface of the door glass. The vehicle outer seal lip or the vehicle inner seal lip has a door glass side tip to slide with the door glass, and the door glass side tip abuts the door glass at a distance of from one-half or more of a thickness of the door glass to 8 mm or less from a tip of the door glass.

### CROSS REFERENCE TO RELATED APPLICATION

This application claims the priority benefit of Japanese Patent Application No. 2023-010711 filed on Jan. 27, 2023. The entirely of the above-mentioned patent application is hereby incorporated by reference herein and made a part of this application.

### BACKGROUND OF THE INVENTION

### (1) Field of the Invention

The present invention relates to a glass run attached to a door frame formed on a door of a vehicle such as an automobile.

### (2) Description of Related Art

In a door of a vehicle, a door frame is provided at an upper part of a door body, and a glass run having a channel shape is fit-engaged in a door frame groove formed on an inner peripheral edge of the door frame. The glass run includes a glass seal at a vehicle outer side and at a vehicle inner side to guide an up and down movement of a door glass as well as to seal a passenger compartment from the vehicle outer side and the vehicle inner side.

The glass run described above has a basic framework (body part) of a bottom wall, a vehicle outer side wall located at a vehicle outer side of the bottom wall, and a vehicle inner side wall located at a vehicle inner side of the bottom wall. Here, typically a vehicle outer seal lip extends from a tip of the vehicle outer side wall or surroundings thereof toward an inner side of the body part, and a vehicle inner seal lip extends from a tip of the vehicle inner side wall or surroundings thereof toward the inner side of the body part. The body part of the glass run is attached to the door frame groove formed on the inner peripheral edge of the door frame of the door of the vehicle; and the door glass moving up and down has peripheral edges of its outer and inner surfaces sandwiched and sealed by the vehicle outer seal lip and the vehicle inner seal lip. The glass run supports the peripheral edges of the door glass to facilitate the door glass to smoothly move up and down, and further, reduces rattling of the door glass during the up and down movement.

Improving quietness of a vehicle such as an automobile increases comfort of a passenger and thus, a degree of appeal for improving product competitiveness is higher. In an electric automobile expected to spread rapidly in the future, a conventionally installed engine is removed. When an engine sound has been removed, remaining noise is mainly road noise and wind noise.

The wind noise is a sound generated by wind hitting a vehicle when the vehicle is traveling; and the sound generated outside the passenger compartment transmits through a vehicle body to reach the passenger compartment. A glass run may also reduce noise caused by a vibration of a door glass, the noise particularly in a high frequency range of 1 kHz or higher. A study is being conducted to increase a reduction effect of this type. As a technique to reduce the noise caused by the glass run, for example, Japanese Patent Application Laid-Open No. 2021-24388 is known. Japanese Patent Application Laid-Open No. 2021-24388 relates to a sound transmitting path in the glass run (shown on arrow B in FIG. 8 of Japanese Patent Application Laid-Open No. 2021-24388).

As illustrated in FIG. 7, a glass run 100 has a basic framework of a bottom wall 200, a vehicle outer side wall 300, and a vehicle inner side wall 400, and is formed in a channel shape (having a substantially U-shaped cross section). The vehicle inner seal lip includes a first vehicle inner seal lip 470, and a second vehicle inner seal lip 480 formed closer to the bottom wall 200 than the first vehicle inner seal lip 470. The first vehicle inner seal lip 470 and the second vehicle inner seal lip 480 are both formed toward the bottom wall 200, and do not abut each other when sliding with a door glass 600. Between the first vehicle inner seal lip 470 and the second vehicle inner seal lip 480, a sub lip 500 diagonally protrudes toward a vehicle inner surface of the first vehicle inner seal lip 470. When the first vehicle inner seal lip 470 slides with the door glass 600, the sub lip 500 abuts the vehicle inner surface of the first vehicle inner seal lip 470.

In the glass run 100, as shown with greater and smaller arrows in FIG. 7, the first vehicle inner seal lip 470 is set to be greater in pressing force to a vehicle inner surface of the door glass 600 than the second vehicle inner seal lip 480.

Meanwhile, in response to electrification of the vehicles that is expected to spread, further improvement in quietness is required of the vehicles, and the door glass attached to the door and surroundings thereof need to meet a strong requirement of the further improvement. Countermeasures, such as increasing a thickness of the door glass and setting an acoustic glass have been implemented, which however causes an increase in weight and cost.

In order to allow a vibration energy of the door glass to efficiently flow to the glass run and dissipate to achieve more effective vibration control, and further reduce the noise to meet the strong requirement of further improvement in quietness of the vehicle, the present invention provides a glass run configured to reduce the noise inside the vehicle in a simple structure, by modifying the conventional structure with focus on a location where each of the seal lips of the glass run abuts the door glass as well as the pressing force from the corresponding seal lip to the door glass at the location. A typically used seal lip abuts the door glass at a distance of approximately 10 mm from a tip of the door glass.

In order to achieve the object above, provided is a glass run according to a first disclosed aspect, the glass run having a basic framework of a bottom wall, a vehicle outer side wall, and a vehicle inner side wall, the basic framework being attached to a door frame groove formed on a door frame, the glass run configured to guide an up and down movement of a door glass. The glass run includes at least one of: a vehicle outer seal lip extending from a vehicle inner surface of the vehicle outer side wall toward the bottom wall to slide with a vehicle outer surface of the door glass; and
a vehicle inner seal lip extending from a vehicle outer surface of the vehicle inner side wall toward the bottom wall to slide with a vehicle inner surface of the door glass. In the glass run, the vehicle outer seal lip or the vehicle inner seal lip has a door glass side tip to slide with the door glass, and the door glass side tip of the vehicle outer seal lip or of the vehicle inner seal lip abuts the door glass at a distance of from one-half or more of a thickness of the door glass to 8 mm or less from a tip of the door glass.

The glass run according to the first disclosed aspect has the basic framework of the bottom wall, the vehicle outer side wall, and the vehicle inner side wall, the basic framework being attached to the door frame groove formed on the door frame, and is configured to guide the up and down movement of the door glass. The glass run includes at least one of the vehicle outer seal lip extending from the vehicle inner surface of the vehicle outer side wall toward the bottom wall to slide with the vehicle outer surface of the door glass, and the vehicle inner seal lip extending from the vehicle outer surface of the vehicle inner side wall toward the bottom wall to slide with the vehicle inner surface of the door glass. In the glass run, the vehicle outer seal lip or the vehicle inner seal lip has the door glass side tip to slide with the door glass, and the door glass side tip abuts the door glass at the distance of from one-half or more of the thickness of the door glass to 8 mm or less from the tip of the door glass. With this configuration, the vehicle outer seal lip or the vehicle inner seal lip of the glass run abutting the door glass at closer to the tip of the door glass is allowed to efficiently absorb the vibration energy generated by the door glass vibrating in response to the vibration of the vehicle when traveling. Then, the vibration dissipates, leading to less generation of noise.

Note that, when the vehicle outer seal lip or the vehicle inner seal lip of the glass run abuts the door glass at a distance of less than one-half of the thickness of the door glass from the tip of the door glass, due to a shape of the tip of the door glass, the glass run may not reliably abut the door glass and thus, the vibration may not reliably dissipate. Concurrently, when the vehicle outer seal lip or the vehicle inner seal lip of the glass run abuts the door glass at a distance of more than 8 mm from the tip of the door glass, the effect is reduced to the conventional level.

Provided is a glass run according to a second disclosed aspect, the glass run having a basic framework of a bottom wall, a vehicle outer side wall, and a vehicle inner side wall, the basic framework being attached to a door frame groove formed on a door frame, the glass run configured to guide an up and down movement of a door glass. The glass run includes a vehicle inner seal lip extending from a vehicle outer surface of the vehicle inner side wall toward the bottom wall to slide with a vehicle inner surface of the door glass. In the glass run, the vehicle inner seal lip includes at least a first vehicle inner seal lip, and a second vehicle inner seal lip formed closer to the bottom wall than the first vehicle inner seal lip. The second vehicle inner seal lip has a door glass side tip to slide with the door glass, the door glass side tip of the second vehicle inner seal lip abuts the door glass at a distance of from one-half or more of a thickness of the door glass to 8 mm or less from a tip of the door glass, and the second vehicle inner seal lip is greater in pressing force to the door glass than the first vehicle inner seal lip.

The glass run according to the second disclosed aspect includes the vehicle inner seal lip extending from the vehicle outer surface of the vehicle inner side wall toward the bottom wall to slide with the vehicle inner surface of the door glass. The vehicle inner seal lip includes at least the first vehicle inner seal lip, and the second vehicle inner seal lip formed closer to the bottom wall than the first vehicle inner seal lip. The second vehicle inner seal lip has the door glass side tip to slide with the door glass, the door glass side tip abutting the door glass at the distance of from one-half or more of the thickness of the door glass to 8 mm or less from the tip of the door glass, and the second vehicle inner seal lip is greater in pressing force to the door glass than the first vehicle inner seal lip. With this configuration, the second vehicle inner seal lip pressing firmly the tip of the door glass is allowed to efficiently absorb the vibration energy generated by the door glass vibrating in response to the vibration of the vehicle when traveling. Then, the vibration dissipates, leading to less generation of noise.

In a third disclosed aspect, with the glass run according to the second disclosed aspect, a sub lip is formed between the second vehicle inner seal lip and the bottom wall, the sub lip protruding diagonally from the vehicle outer surface of the vehicle inner side wall toward a vehicle inner surface of the second vehicle inner seal lip. When the second vehicle inner seal lip slides with the door glass, the sub lip abuts the vehicle inner surface of the second vehicle inner seal lip.

The glass run according to the third disclosed aspect includes the sub lip between the second vehicle inner seal lip and the bottom wall, the sub lip protruding diagonally from the vehicle outer surface of the vehicle inner side wall toward the vehicle inner surface of the second vehicle inner seal lip. When the second vehicle inner seal lip slides with the door glass, the sub lip abuts the vehicle inner surface of the second vehicle inner seal lip. Thus, the tip of the door glass is further firmly pressed. With this configuration, the second vehicle inner seal lip is allowed to efficiently absorb the vibration energy generated by the door glass vibrating in response to the vibration of the vehicle when traveling. Then, the vibration dissipates, leading to less generation of noise.

### BRIEF DESCRIPTION OF THE DRAWINGS

FIG. 1 is a front view of a door for an automobile;

FIG. 2 is a front view illustrating a glass run used for a door frame in FIG. 1;

FIG. 3 is a sectional view of a glass run according to a first embodiment of the present invention, taken along line A-A in FIG. 1;

FIG. 4A is a diagram of a door glass as seen in its cross-sectional direction, and FIG. 4B is a diagram of the door glass as seen from front. FIGS. 4A and 4B are diagrams for describing measurement of noise;

FIG. 5 is a graph showing a degree of effect of the first embodiment of the present invention;

FIG. 6 is a sectional view of a glass run according to a second embodiment of the present invention, taken along line A-A in FIG. 1 to show the vehicle inner side; and

FIG. 7 is a sectional view of a structure of a conventional glass run to be attached to a vehicle, taken along line A-A in FIG. 1 (Japanese Patent Application Laid-Open No. 2021-24388).

### DETAILED DESCRIPTION OF PREFERRED EMBODIMENTS

A first embodiment of the present invention will be described with reference to FIGS. 1 to 5. FIG. 1 is a front view of a front door 1 on a left side of the automobile as seen from a vehicle outer side. The front door 1 includes a door body 2, and a door frame 3 attached to an upper edge of the door body 2. The door frame 3 and the upper edge of the door body 2 form a window opening. A glass run 10 is attached to an inner peripheral edge of the window opening and the inside of the door body 2 to guide an up and down movement of a door glass 4. The present invention is applicable not only to the front door 1 on the left side but also to a front door on a right side, rear doors on left and right sides. Further, the present invention is applicable to a sliding door at which the door glass moves up and down.

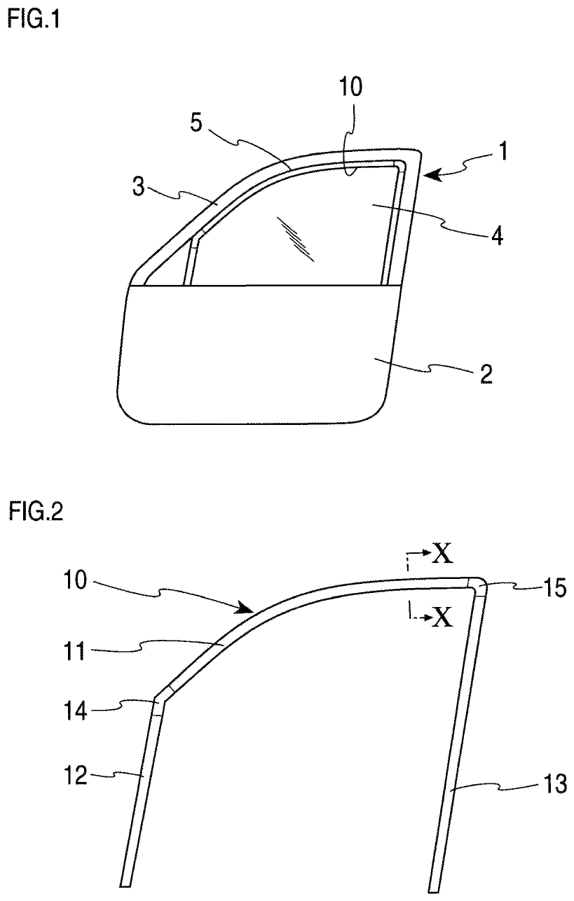

FIG. 2 is a simplified front view of the glass run 10 alone, as seen from the vehicle outer side. The glass run 10 includes a first extruded portion 11 corresponding to a lateral frame of the door frame 3, a second extruded portion 12 corresponding to a vertical frame of the door frame 3 at a front side of the front door 1, and a third extruded portion 13 corresponding to a vertical frame of the door frame 3 at a rear side of the front door 1. A front end of the first extruded portion 11 is connected to an upper end of the second extruded portion 12 by a first molded portion 14. A rear end of the first extruded portion 11 is connected to an upper end of the third extruded portion 13 by a second molded portion 15.

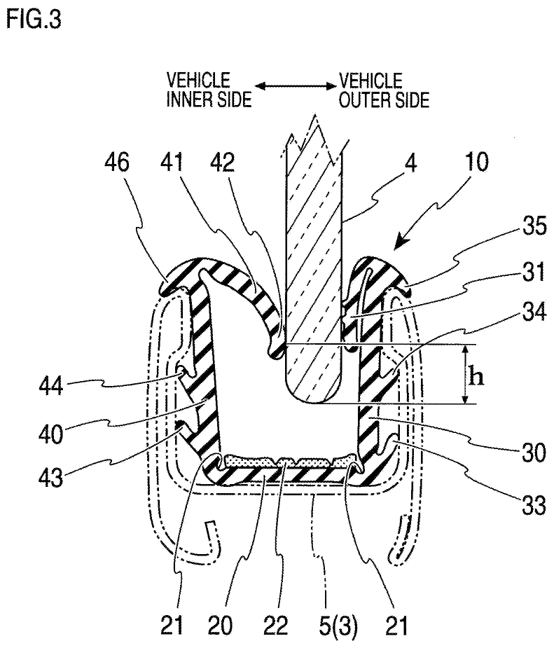

FIG. 3 is a sectional view of the glass run 10 according to the first embodiment of the present invention, in which the glass run 10 is attached to a door frame groove 5 of the door frame 3 and abuts the door glass 4. The glass run 10 has a basic framework of a bottom wall 20, a vehicle outer side wall 30, and a vehicle inner side wall 40, and is formed in a channel shape (having a substantially U-shaped cross section). The bottom wall 20, the vehicle outer side wall 30, and the vehicle inner side wall 40 are connected to expand in a free state by a groove 21 at the vehicle outer side and a groove 21 at a vehicle inner side.

The bottom wall 20 is formed in a substantially plate shape, and a plurality of bottom wall recesses 22 are continuously formed in parallel on an inner surface of the bottom wall 20 (closer to the door glass 4) in a longitudinal direction.

On a vehicle outer surface of the vehicle outer side wall 30, a first vehicle outer holding lip 33 is formed close to where the vehicle outer side wall 30 is connected to the bottom wall 20, and a second vehicle outer holding lip 34 is formed toward a tip of the vehicle outer side wall 30. The first vehicle outer holding lip 33 and the second vehicle outer holding lip 34 are to engage with the door frame groove 5. When the glass run 10 is attached to the vehicle, the first vehicle outer holding lip 33 and the second vehicle outer holding lip 34 are to abut an inner wall of the door frame groove 5 expanding to the vehicle outer side.

At a tip of a vehicle inner surface of the vehicle outer side wall 30, a vehicle outer seal lip 31 is formed to extend toward the bottom wall 20 and to slide with a vehicle outer surface of the door glass 4.

At a base of the vehicle outer seal lip 31, a vehicle outer cover lip 35 is formed toward the vehicle outer side. When the glass run 10 is attached to the vehicle, the vehicle outer cover lip 35 is to cover a vehicle outer side tip of the door frame groove 5 having a bent shape and fix the vehicle outer side wall 30 to the door frame groove 5. Concurrently, the vehicle outer cover lip 35 improves sealability with the door frame groove 5 for prevention of any inclusion of raindrops, dust, or noise.

At a tip of a vehicle outer surface of the vehicle inner side wall 40, a vehicle inner seal lip 41 is formed to extend toward the bottom wall 20 and to slide with a vehicle inner surface of the door glass 4.

On a vehicle inner surface of the vehicle inner side wall 40, a first vehicle inner holding lip 43 is formed close to where the vehicle inner side wall 40 is connected to the bottom wall 20, and a second vehicle inner holding lip 44 is formed toward the tip of the vehicle inner side wall 40. When the glass run 10 is attached to the vehicle, the first vehicle inner holding lip 43 and the second vehicle inner holding lip 44 are to abut the inner wall of the door frame groove 5 expanding to the vehicle inner side.

At the tip of the vehicle inner side wall 40, a vehicle inner cover lip 46 is formed toward the vehicle inner side. When the glass run 10 is attached to the vehicle, the vehicle inner cover lip 46 is to cover a vehicle inner side tip of the door frame groove 5 having the bent shape and fix the vehicle inner side wall 40 to the door frame groove 5. Concurrently, the vehicle inner cover lip 46 improves the sealability with the with the door frame groove 5 for prevention of any inclusion of noise.

With the glass run 10 according to the first embodiment, the vehicle inner seal lip 41 abuts the door glass 4 at closer to the tip of the door glass 4 than the vehicle outer seal lip 31. The vehicle inner seal lip 41 includes a door glass side tip 42 to abut the door glass 4.

In this embodiment, the glass run 10 is produced by extrusion molding using olefinic thermoplastic elastomer (TPO).

In the embodiments of the present invention, the glass run 10 may be formed of rubber, thermoplastic elastomer, soft synthetic resin, or others. As the rubber, ethylene propylene diene rubber (EPDM) is preferable, and as the thermoplastic elastomer, olefinic thermoplastic elastomer (TPO) or dynamic cross-linking thermoplastic elastomer (TPV) is preferable from viewpoints of weather resistance, recycling, cost, or others.

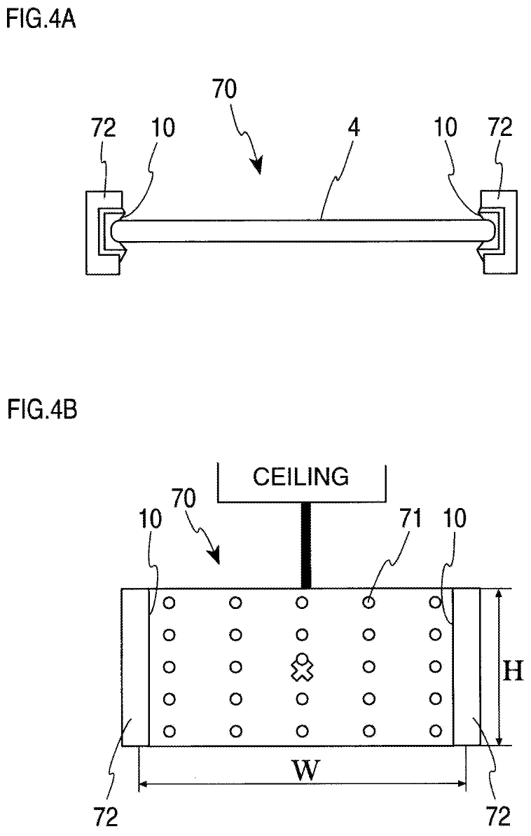

FIGS. 4A and 4B are diagrams for describing an effect in reducing noise. The noise was measured using a hammer test. The hammer test was performed by striking an object with an impulse hammer (also referred to as an impact hammer) for measurement to oscillate the object, detecting vibration caused by the oscillation with an acceleration sensor, and measuring the noise with a fast fourier transform (FFT) analyzer.

FIG. 4A is a diagram of a measured member 70 as seen in a cross-sectional direction of the door glass 4. Here, the glass run 10 is attached to a frame jig 72, and the door glass 4 is inserted in the glass run 10. The door glass 4 used here has a thickness of 4 mm, and the tip of the door glass 4 has a radius of 2 mm as one-half of the thickness of the door glass 4.

In the measurement, as illustrated in FIG. 4B, the door glass 4 as the measured member 70 of FIG. 4A was hung from a ceiling, and the frame jig 72 was stood against and fixed to a wall (not illustrated). Then, an acceleration sensor 71 was attached to the door glass 4 of 600 mm in width (W) and 400 mm in height (H), at 25 (5×5) measured spots in total. An impulse hammer was used to strike a center X of the door glass 4 to oscillate the door glass 4, and the acceleration sensor 71 was used to detect the vibration caused by the oscillation. The center X was to be oscillated and thus, the acceleration sensor 71 was attached not to the center X but to 10 mm above the center X. Oscillation was measured at the 25 measured spots, and an average of the oscillations was acquired to confirm the effect.

FIG. 5 is a graph showing a degree of effect of the embodiment of the present invention. More specifically, the graph shows a degree of effect in dissipating the vibration with respect to a distance h (FIG. 3) between the tip of the door glass 4 and the spot in the door glass 4 where the door glass side tip 42 of the vehicle inner seal lip 41 abuts at a frequency of 4 kHz. FIG. 5 shows a higher degree of effect toward the right on the drawing. FIG. 5 shows, at the left end on the drawing, a degree of effect when the distance h from the tip of the door glass 4 is 10 mm (conventional structure).

As clearly seen in FIG. 5, as the distance h from the tip of the door glass 4 was smaller, the effect was greater. When the distance h was 2 mm as one-half of the thickness of the door glass 4, the effect was greatest. FIG. 5 shows the effect at the frequency of 4 kHz, but within a frequency range of 2.5 kHz to 5 kHz too, the similar tendency was confirmed. In other words, as the distance h from the tip of the door glass 4 was smaller, the effect was greater.

Note that, the vibration did not linearly dissipate in response to the distance h from the tip of the door glass 4, but gradually dissipated as the distance h was greater. With the distance h from the tip of the door glass 4 being up until 8 mm, the vibration effectively and remarkably dissipated.

In this embodiment, the door glass 4 of 4 mm thickness was used, but the smallest thickness of the door glass is 3.1 mm and the smallest radius of the tip of the door glass is thus 1.6 mm as one-half of the thickness of the door glass. When the door glass 4 of 3.1 mm is used, the door glass side tip 42 is to abut the door glass 4 at a distance of 1.6 mm from the tip of the door glass 4, so as to achieve the same effect as above.

The present invention is remarkably effective as compared with the conventional structure, when the door glass side tip 42 of the vehicle inner seal lip 41 abuts the door glass 4 at a distance of from one-half or more of the thickness of the door glass 4 to 8 mm or less from the tip of the door glass 4. Additionally, the present invention is more effective when the door glass side tip 42 abuts the door glass 4 at a distance of from one-half or more of the thickness of the door glass 4 to 6 mm or less from the tip of the door glass 4, and is further more effective when the door glass side tip 42 abuts the door glass 4 at a distance of from one-half or more of the thickness of the door glass 4 to 4 mm or less from the tip of the door glass 4.

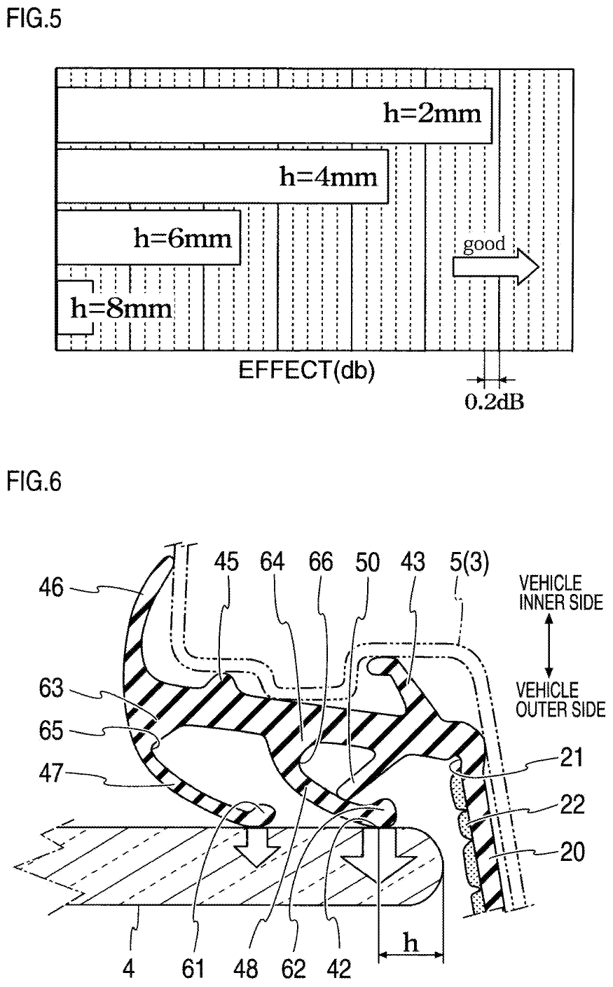

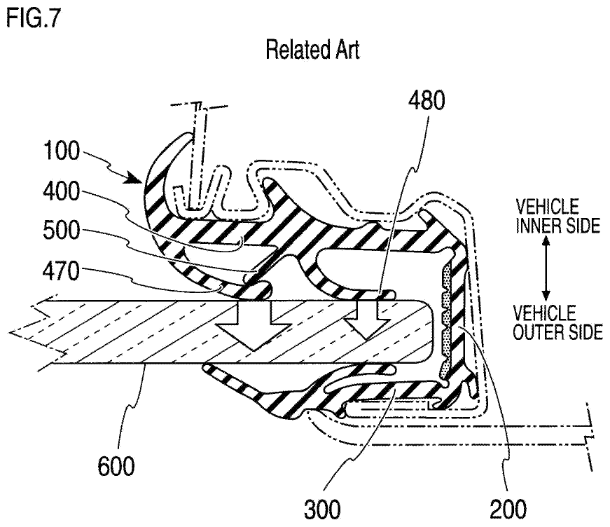

FIG. 6 is a sectional view of a glass run 10 according to a second embodiment of the present invention, taken along line A-A in FIG. 1 to show the vehicle inner side. In the second embodiment, as in the first embodiment, the vehicle outer seal lip 31 and the vehicle inner seal lip 41 abut the door glass 4. Here, the vehicle inner seal lip 41 abuts the door glass 4 at closer to the tip of the door glass 4 and has a feature. Thus, the description below focuses on the vehicle inner seal lip 41 alone.

At the vehicle inner side of the vehicle inner side wall 40, the first vehicle inner holding lip 43 is formed close to where the vehicle inner side wall 40 is connected to the bottom wall 20, and an abutting rib 45 is formed toward the tip of the vehicle inner side wall 40. The door frame groove 5 has curved portions, and the first vehicle inner holding lip 43 and the abutting rib 45 abut the curved portions of the door frame groove 5. At the tip of the vehicle inner side wall 40, the vehicle inner cover lip 46 is formed.

The vehicle inner seal lip 41 includes a first vehicle inner seal lip 47 and a second vehicle inner seal lip 48 extending from the vehicle outer surface of the vehicle inner side wall 40; and the second vehicle inner seal lip 48 is formed closer to the bottom wall 20 than the first vehicle inner seal lip 47. The first vehicle inner seal lip 47 and the second vehicle inner seal lip 48 both extend toward the bottom wall 20.

The second vehicle inner seal lip 48 is formed greater in thickness than the first vehicle inner seal lip 47, so that the second vehicle inner seal lip 48 is greater in pressing force to the vehicle inner surface of the door glass 4 than the first vehicle inner seal lip 47.

At a tip of the first vehicle inner seal lip 47, a bulging portion 61 is formed; and at a tip of the second vehicle inner seal lip 48, a bulging portion 62 is formed. The bulging portions 61 and 62, each having a thickness, protrude toward the vehicle inner side wall 40, and protect the tips of the first vehicle inner seal lip 47 and the second vehicle inner seal lip 48 from being bent when the first and second vehicle inner seal lips 47 and 48 slide with the door glass 4. With this configuration, the first vehicle inner seal lip 47 and the second vehicle inner seal lip 48 are less likely to be reduced in pressing force to the vehicle inner surface of the door glass 4.

At a base of the first vehicle inner seal lip 47 and at a base of the second vehicle inner seal lip 48 on the vehicle inner side wall 40, a base portion 63 and a base portion 64 are respectively formed sticking out from the vehicle inner side wall 40 toward the door glass 4. With the base portions 63 and 64, the first vehicle inner seal lip 47 and the second vehicle inner seal lip 48 are reduced in length, thereby shifting a resonance point of the transmitting sound to a higher frequency. This prevents the vibration of the first vehicle inner seal lip 47 and the second vehicle inner seal lip 48 caused by the transmitting sound, and thus prevents radiation sound generated by the vibration in the passenger compartment. Concurrently, the bases of the first vehicle inner seal lip 47 and the second vehicle inner seal lip 48 are to be more rigid.

At upper portions (vehicle outer side) of the base portions 63 and 64 and toward the bottom wall 20, a recess 65 and a recess 66 are respectively formed. When the first vehicle inner seal lip 47 and the second vehicle inner seal lip 48 slide with the door glass 4, the first and second vehicle inner seal lips 47 and 48 smoothly tilt toward the bottom wall 20 from the recesses 65 and 66 as the respective starting points, which improves the followability to the door glass 4. This configuration further facilitates the first and second vehicle inner seal lips 47 and 48 to smoothly abut and slide with the door glass 4, and concurrently, shields the transmitting sound more effectively. The recesses 65 and 66 may not be formed.

Additionally, between the second vehicle inner seal lip 48 and the bottom wall 20, a sub lip 50 is formed diagonally protruding toward a vehicle inner surface of the second vehicle inner seal lip 48 and toward the base of the second vehicle inner seal lip 48. When the second vehicle inner seal lip 48 slides with the door glass 4, the sub lip 50 abuts the vehicle inner surface of the second vehicle inner seal lip 48.

When the door glass side tip 42 of the second vehicle inner seal lip 48 slides with the door glass 4, the sub lip 50 presses a rear surface of the second vehicle inner seal lip 48, thereby increasing abutting force of the second vehicle inner seal lip 48 to the door glass 4. With this configuration, the vehicle inner seal lip 48 is allowed to efficiently absorb the vibration energy generated by the door glass 4 vibrating in response to the vibration of the vehicle when traveling. Then, the vibration dissipates, leading to less generation of noise.

As shown with greater and smaller arrows in FIG. 6, the second vehicle inner seal lip 48 is greater in pressing force to the door glass 4 than the first vehicle inner seal lip 47. In the second embodiment, as the second vehicle inner seal lip 48 is greater in reaction force to the door glass 4 than the first vehicle inner seal lip 47, the effect is greater.

In the second embodiment, similarly to the first embodiment, as the door glass side tip 42 of the second vehicle inner seal lip 48 approaches the tip of the door glass 4 to abut the door glass 4 within the frequency range of 2.5 kHz to 5 kHz, the vibration dissipates more effectively.

With the tip of the door glass 4 being firmly held, the glass run 10 is allowed to efficiently absorb the vibration energy generated by the door glass 4 vibrating in response to the vibration of the vehicle when traveling. With this configuration, the vibration dissipates, leading to less generation of noise.

The present invention is not limited to the foregoing embodiments, and various modifications may be made within a range not deviating from the object of the present invention.

For example, in the first embodiment and the second embodiment, the relationship between the vehicle inner seal lip and the door glass may also be applied to the relationship between the vehicle outer seal lip and the door glass.

What is claimed is:

1. A glass run having a basic framework of a bottom wall, a vehicle outer side wall, and a vehicle inner side wall, the basic framework being attached to a door frame groove formed on a door frame, the glass run configured to guide an up and down movement of a door glass,
the glass run comprising at least one of:
a vehicle outer seal lip extending from a vehicle inner surface of the vehicle outer side wall toward the bottom wall to slide with a vehicle outer surface of the door glass; and
a vehicle inner seal lip extending from a vehicle outer surface of the vehicle inner side wall toward the bottom wall to slide with a vehicle inner surface of the door glass, wherein
the vehicle outer seal lip or the vehicle inner seal lip has a door glass side tip to slide with the door glass, and
the door glass side tip of the vehicle outer seal lip or of the vehicle inner seal lip abuts the door glass at a distance of from one-half or more of a thickness of the door glass to 8 mm or less from a tip of the door glass.

2. A glass run having a basic framework of a bottom wall, a vehicle outer side wall, and a vehicle inner side wall, the basic framework being attached to a door frame groove formed on a door frame, the glass run configured to guide an up and down movement of a door glass,
the glass run comprising a vehicle inner seal lip extending from a vehicle outer surface of the vehicle inner side wall toward the bottom wall to slide with a vehicle inner surface of the door glass, wherein
the vehicle inner seal lip includes at least a first vehicle inner seal lip, and a second vehicle inner seal lip formed closer to the bottom wall than the first vehicle inner seal lip,
the second vehicle inner seal lip has a door glass side tip to slide with the door glass,
the door glass side tip of the second vehicle inner seal lip abuts the door glass at a distance of from one-half or more of a thickness of the door glass to 8 mm or less from a tip of the door glass, and
the second vehicle inner seal lip is greater in pressing force to the door glass than the first vehicle inner seal lip.

3. The glass run according to claim 2, wherein
a sub lip is formed between the second vehicle inner seal lip and the bottom wall, the sub lip protruding diagonally from the vehicle outer surface of the vehicle inner side wall toward a vehicle inner surface of the second vehicle inner seal lip, and
when the second vehicle inner seal lip slides with the door glass, the sub lip abuts the vehicle inner surface of the second vehicle inner seal lip.
